(19) United States
(12) Patent Application Publication
(10) Pub. No.: US 2025/0159043 A1
(43) Pub. Date: May 15, 2025

(54) REMOTE DIRECT MEMORY ACCESS DATA REPLICATION MODEL

(71) Applicant: Microsoft Technology Licensing, LLC, Redmond, WA (US)

(72) Inventors: Yingrui TONG, Shanghai (CN); Sijia HUANG, Shanghai (CN); Vadim MAKHERVAKS, Bellevue, WA (US); Madhav Himanshubhai PANDYA, Redmond, WA (US)

(21) Appl. No.: 18/587,247

(22) Filed: Feb. 26, 2024

Related U.S. Application Data
(60) Provisional application No. 63/598,420, filed on Nov. 13, 2023.

(51) Int. Cl. H04L 67/1097; G06F 11/34

(52) U.S. Cl. CPC H04L 67/1097; G06F 11/3476

(57) ABSTRACT

A computer-implemented method for replicating a log to a remote computer system is disclosed. The method involves identifying a log comprising a data portion and a metadata portion for replication. The data portion is sent to the remote computer system using a Remote Direct Memory Access (RDMA) write operation, while the metadata portion is sent using a first RDMA send operation after the data portion has been sent. The method further includes identifying a second RDMA send operation received from the remote computer system, which indicates the completion of the first RDMA send operation. Based on identifying the second RDMA send operation, the method determines the completion of log replication to the remote computer system. This method enables efficient and reliable replication of logs in a computer system.

### CROSS-REFERENCE TO RELATED APPLICATIONS

This application claims priority to, and the benefit of, U.S. Provisional Application Ser. No. 63/598,420, filed Nov. 13, 2023, and entitled “REMOTE DIRECT MEMORY ACCESS DATA REPLICATION MODEL,” the entire contents of which are incorporated by reference herein in their entirety.

### BACKGROUND

Cloud computing has revolutionized the way data is stored and accessed, providing scalable, flexible, and cost-effective solutions for businesses and individuals alike. A core component of these systems is the concept of virtualization, which allows for the creation of virtual machines (VMs) or containers that can utilize resources abstracted from the physical hardware. VMs and containers utilize storage resources, typically in the form of virtual disks. Oftentimes, virtual disks are not tied to any specific physical storage device, but rather, they are abstracted representations of storage space that can be dynamically allocated and adjusted based on the requirements of each VM or container. This abstraction allows for greater flexibility and scalability, as storage resources can be allocated and adjusted dynamically based on the requirements of the VM or container.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a log for replication to a remote computer system, the log including a data portion and a metadata portion; sending the data portion to the remote computer system using a Remote Direct Memory Access (RDMA) write operation; sending the metadata portion to the remote computer system using a first RDMA send operation after sending the data portion to the remote computer system using the RDMA write operation; identifying a second RDMA send operation received from the remote computer system, the second RDMA send operation signaling completion of the first RDMA send operation; and determining a completion of replication of the log to the remote computer system based on identifying the second RDMA send operation.

In some aspects, the techniques described herein relate to methods, systems, and computer program products, including: receiving an RDMA write operation from a remote computer system, the RDMA write operation including a data portion of a log; storing the data portion of the log in a memory without use of the processor system; receiving a first RDMA send operation from the remote computer system, the first RDMA send operation including a metadata portion of the log; storing the metadata portion of the log in the memory with use of the processor system; and sending a second RDMA send operation to the remote computer system after storing the metadata portion of the log in the memory.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that includes a host cache service operating within a cloud environment.

FIG. 2 illustrates an example of storing multiple data and metadata rings within a memory.

FIG. 3 illustrates an example of a computer architecture that utilizes a Remote Direct Memory Access (RDMA) replication model.

FIG. 4 illustrates a flow chart of an example of a method for using an RDMA replication model to replicate a log.

### DETAILED DESCRIPTION

The performance of cloud environments is closely tied to the performance of storage Input/Output (I/O) operations within those environments. For example, the performance of a virtual machine (VM) or container can be impacted greatly by the performance of storage I/O operations used by the VM or container to access (e.g., read from or write to) a virtual disk. Some embodiments described herein are operable within the context of a host cache (e.g., a cache service operating at a VM/container host) that improves the performance of I/O operations of a hosted VM or container for accessing a virtual disk.

In some embodiments, a host cache utilizes persistent memory (PMem) and Non-Volatile Memory Express (NVMe) technologies to improve storage I/O performance within a cloud environment. PMem refers to non-volatile memory technologies (e.g., INTEL OPTANE, SAMSUNG Z-NAND) that retain their stored contents through power cycles. This contrasts with conventional volatile memory technologies such as dynamic random-access memory (DRAM) that lose their stored contents through power cycles. Some PMem technology is available as non-volatile media that fits in a computer's standard memory slot (e.g., Dual Inline Memory Module, or DIMM, memory slot) and is thus addressable as random-access memory (RAM).

NVMe refers to a type of non-volatile block storage technology that uses the Peripheral Component Interconnect Express (PCIe) bus and is designed to leverage the capabilities of high-speed storage devices like solid-state drives (SSDs), providing faster data transfer rates compared to traditional storage interfaces (e.g., Serial AT Attachment (SATA)). NVMe devices are particularly beneficial in data-intensive applications due to their low latency I/O and high I/O throughput compared to SATA devices. NVMe devices can also support multiple I/O queues, which further enhance their performance capabilities.

Currently, PMem devices have slower I/O access times than DRAM, but they provide higher I/O throughput than SSD and NVMe. Compared to DRAM, PMem modules come in much larger capacities and are less expensive per gigabyte (GB), but they are more expensive per GB than NVMe. Thus, PMem is often positioned as lower-capacity “top-tier” high-performance non-volatile storage that can be backed in a “lower-tier” by larger-capacity NVMe drives, SSDs, and the like. As a result, PMem is sometimes referred to as “storage-class memory.”

In embodiments, a host cache improves the performance of storage I/O operations of VMs and/or containers to their virtual disks by utilizing NVMe protocols. For example, some embodiments use a virtual NVMe controller to expose virtual disks to VMs and/or containers, enabling those VMs/containers to utilize NVMe queues, buffers, control registers, etc., directly. Additionally, or alternatively, a host cache improves the performance of storage I/O operations of VMs and/or containers to their virtual disks by leveraging PMem as high-performance non-volatile storage for caching reads and/or writes.

In traditional networking methods, data transfer between computers typically involves multiple data copies and context switches, which can significantly increase latency and CPU overhead. For example, when data is sent over a network, it is usually copied from the sending application's memory to the operating system kernel memory, then to the network protocol stack, and finally to the network interface card (NIC). Upon reaching the destination, the data is copied in reverse order from the NIC to the destination application's memory. This process is not only time-consuming but also burdens the CPU, which could otherwise be used for processing the actual data.

To address these inefficiencies, Remote Direct Memory Access (RDMA) was developed to enable more direct data transfers. RDMA-capable NICs, often referred to as RDMA Network Interface Cards (RNICs), allow applications on different computers to transfer data directly between their memory spaces without the need for significant CPU intervention. This is achieved by establishing a connection and pre-registering the memory regions involved in the transfer, which allows the RNICs to access the memory directly using Direct Memory Access (DMA) operations.

Some embodiments described herein utilize RDMA technology to replicate write cache logs from one host to another. RDMA technology allows data to be transferred directly from the memory of one computer to the memory of another computer with little or no involvement of the CPU or OS of the remote system. This direct memory-to-memory data transfer can improve throughput and performance while reducing latency, making it particularly useful in high-performance computing and data center environments.

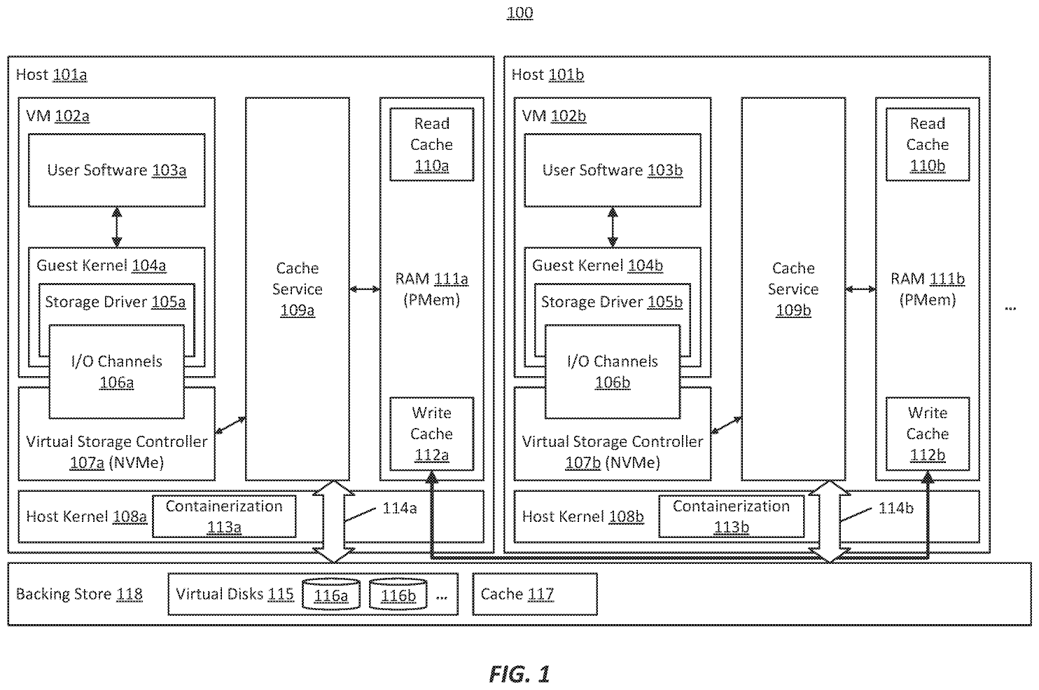

FIG. 1 illustrates an example of a host cache service operating within a cloud environment 100. In FIG. 1, cloud environment 100 includes hosts (e.g., host 101a, host 101b; collectively, hosts 101). An ellipsis to the right of host 101b indicates that hosts 101 can include any number of hosts (e.g., one or more hosts). In embodiments, each host is a VM host and/or a container host. Cloud environment 100 also includes a backing store 118 (or a plurality of backing stores) storing, e.g., virtual disks 115 (e.g., virtual disk 116a, virtual disk 116b) for use by VMs/containers operating at hosts 101, de-staged cache data (e.g., cache 117), etc.

In the example of FIG. 1, each host of hosts 101 includes a corresponding host operating system (OS) including a corresponding host kernel (e.g., host kernel 108a, host kernel 108b) that each includes (or interoperates with) a containerization component (e.g., containerization component 113a, containerization component 113b) that supports the creation of one or more VMs and/or one or more containers at the host. Examples of containerization components include a hypervisor (or elements of a hypervisor stack) and a containerization engine (e.g., AZURE container services, DOCKER, LINUX Containers). In FIG. 1, each host of hosts 101 includes a VM (e.g., VM 102a, VM 102b). VM 102a and VM 102b are each shown as including a guest kernel (e.g., guest kernel 104a, guest kernel 104b) and user software (e.g., user software 103a, user software 103b).

In FIG. 1, each host of hosts 101 includes a host cache service (e.g., cache service 109a, cache service 109b). In embodiments, a storage driver (e.g., storage driver 105a, storage driver 105b) at each VM/container interacts, via one or more I/O channels (e.g., I/O channels 106a, I/O channels 106b) with a virtual storage controller (e.g., virtual storage controller 107a, virtual storage controller 107b) for its I/O operations, such as I/O operations for accessing virtual disks 115. In embodiments, each host cache service communicates with a virtual storage controller to cache these I/O operations. As one example, in FIG. 1, the virtual storage controllers are shown as being virtual NVMe controllers. In this example, the I/O channels comprise NVMe queues (e.g., administrative queues, submission queues, completion queues), buffers, control registers, and the like.

In embodiments, each host cache service at least temporarily caches reads (e.g., read cache 110a, read cache 110b) and/or writes (e.g., write cache 112a, write cache 112b) in memory (e.g., RAM 111a, RAM 111b). As shown, in some embodiments, memory includes non-volatile PMem. For example, a read cache stores data that has been read (and/or that is predicted to be read) by VMs from backing store 118 (e.g., virtual disks 115), which can improve read I/O performance for those VMs (e.g., by serving reads from the read cache if that data is read more than once). A write cache, on the other hand, stores data that has been written by VMs to virtual disks 115 prior to persisting that data to backing store 118. Write caching allows for faster write operations, as the data can be written to the write cache quickly and then be written to the backing store 118 at a later time (e.g., when the backing store 118 is less busy).

In embodiments, and as indicated by arrow 114a and arrow 114b, each host cache service may persist (e.g., de-stage) cached writes from memory to backing store 118 (e.g., to virtual disks 115 and/or to cache 117). In addition, an arrow that connects write cache 112a and write cache 112b indicates that, in some embodiments, the host cache service replicates cached writes from one host to another (e.g., from host 101a to host 101b, or vice versa).

In embodiments, each write cache (write cache 112a, write cache 112b) is a write-ahead log that is stored as one or more ring buffers in memory (e.g., RAM 111a, RAM 111b). Write-ahead logging (WAL) refers to techniques for providing atomicity and durability in database systems. Write-ahead logs generally include append-only data structures that are used for crash and transaction recovery. With WAL, changes are first recorded as a log entry in a log (e.g., write cache 112a, write cache 112b) and are then written to stable storage (e.g., backing store 118) before the changes are considered committed. A ring buffer is a data structure that uses a single, fixed-size buffer as if connected end-to-end. That is, once the size of the buffer is exceeded, a new buffer replaces the oldest buffer entry.

In embodiments, for each write request from a VM, the host cache service stores a log entry comprising 1) a data portion comprising the data that was written by the VM as part of the write request (e.g., one or more memory pages to be persisted to virtual disks 115), and 2) a metadata portion describing the log entry and the write—e.g., a log identifier, a logical block address (LBA) for the memory page(s) in the data portion, and the like. In embodiments, data portions have a size that aligns cleanly in memory, including in a central processing unit (CPU) cache. For example, if a data portion represents n memory page(s), then the data portion is sized as a multiple of the size of each memory page in RAM 111a, RAM 111b (e.g., a multiple of four kilobytes (KB), a multiple of sixteen KB). If the metadata portion of each log is stored adjacent to its data portion in memory, then this memory alignment is broken. For instance, if the data portion of a log is n memory pages, and the metadata portion of that log is 32 bytes, then that log would require the entirety of n memory pages plus 32 bytes of a final memory page, which wastes most of the final memory page. Additionally, logs sized as n memory pages plus metadata would not fit cleanly across CPU cache lines, eliminating the ability to apply bitwise operations (e.g., for address searching).

In some embodiments, a host cache service utilizes separate ring buffers for data and metadata, which enables the host cache service to maintain clean memory alignments when storing write cache logs. A clean memory alignment refers to arranging data in memory so that it is aligned to certain boundaries, such as memory page sizes, cache line sizes, etc. Maintaining a clean memory alignment can improve memory access performance because aligned data maps to cache line sizes, improving cache hit rates; because an aligned memory access is generally faster for a processor to complete than a non-aligned memory access; and/or because an aligned memory access can avoid some processor exceptions that may otherwise occur with a non-aligned memory access.

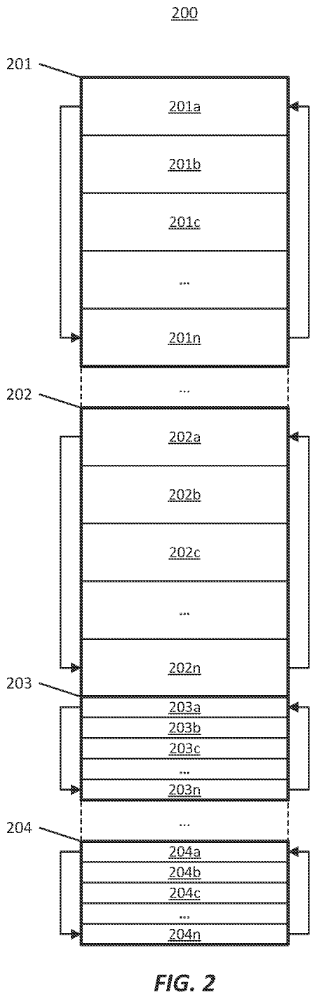

FIG. 2 illustrates an example 200 of storing multiple data and metadata rings within a memory. In example 200, memory is shown as storing a data ring 201 and a data ring 202, each comprising a plurality of entries (e.g., entry 201a to entry 201n for data ring 201 and entry 202a to entry 202n for data ring 202). Arrows indicate that entries are used circularly within each data ring, and an ellipsis within each data ring indicates that a data ring can comprise any number of entries. As indicated by an ellipsis between data ring 201 and data ring 202, in embodiments, a memory can store any number of data rings (e.g., one or more data rings). In some embodiments, multiple data rings are stored contiguously within the memory (e.g., one after the other).

In example 200, the memory is shown as also storing a metadata ring 203 and a metadata ring 204, each comprising a plurality of entries (e.g., entry 203a to entry 203n for metadata ring 203 and entry 204a to entry 204n for metadata ring 204). Arrows indicate that entries are used circularly within each metadata ring, and an ellipsis within each metadata ring indicates that a metadata ring can comprise any number of entries. As indicated by an ellipsis between metadata ring 203 and metadata ring 204, in embodiments, a memory can store any number of metadata rings (e.g., one or more metadata rings). In some embodiments, multiple metadata rings are stored contiguously within the memory. Thus, in these embodiments, multiple metadata rings are stored one after the other within the memory. In some embodiments, a block of data rings and a block of metadata rings are stored contiguously with each other within the memory (e.g., contiguous data rings, then contiguous metadata rings).

In embodiments, each metadata ring corresponds to a different data ring. For example, in example 200, metadata ring 203 corresponds to data ring 201, and metadata ring 204 corresponds to data ring 202. In embodiments, each entry in a metadata ring corresponds to a corresponding entry in a data ring (and vice versa). For example, entries 203a-203n correspond to entries 201a-201n, respectively, and entries 204a-204n correspond to entries 202a-202n, respectively.

In some embodiments, each pairing of data and metadata rings corresponds to a different entity, such as a VM or container, for which data is cached. This enables the data cached for each entity to be separated and localized within memory.

In embodiments, by storing data and metadata in separate rings, as shown in example 200, a host cache service can ensure that data and metadata are aligned to memory page boundaries, which minimizes (and even eliminates) any wasted memory that would result if data and metadata were stored together. For example, each data ring may be sized to correspond to the size of a memory page, or to a multiple of the memory page size. Additionally, metadata rings may be sized such that a plurality of contiguously stored metadata rings corresponds to the size of a memory page or to a multiple of the memory page size.

Some embodiments replicate write cache logs between hosts, such as replicating one or more logs from write cache 112a to write cache 112b or vice versa. This replication ensures data reliability and availability. For example, absent replication, if host 101a were to go down (e.g., crash, power down) or become unresponsive before persisting a log from write cache 112a to backing store 118 (e.g., cache 117), that log could become temporarily unavailable (e.g., until host 101a is brought back up or becomes responsive again) or even be lost. Thus, in embodiments, host cache service instances (e.g., cache service 109a, cache service 109b) cooperate with one another to replicate logs across hosts, ensuring the reliability and availability of those logs before they are persisted to backing store 118.

In embodiments, a host cache service commits a write I/O operation (e.g., acknowledges completion of the write I/O operation to a virtual storage controller, a storage driver, etc.) after replication of that operation's corresponding data has been completed. This means that a write I/O operation can be committed before the data written by the operation has been de-staged to backing store 118 while ensuring the reliability and availability of the data written. In embodiments, committing a write I/O operation prior to that data being written to a backing store shortens the I/O path for the I/O operation, which enables lower latency for write I/O operations than would be possible absent the host cache service described herein.

As mentioned, some embodiments utilize RDMA technology to replicate write cache logs from one host to another. RDMA technology allows data to be transferred directly from the memory of one computer (e.g., host 101a) to the memory of another computer (e.g., host 101b) with little or no involvement of the CPU or OS of the remote system. This direct memory-to-memory data transfer can improve throughput and performance while reducing latency, making it particularly useful in high-performance computing and data center environments, such as cloud environment 100.

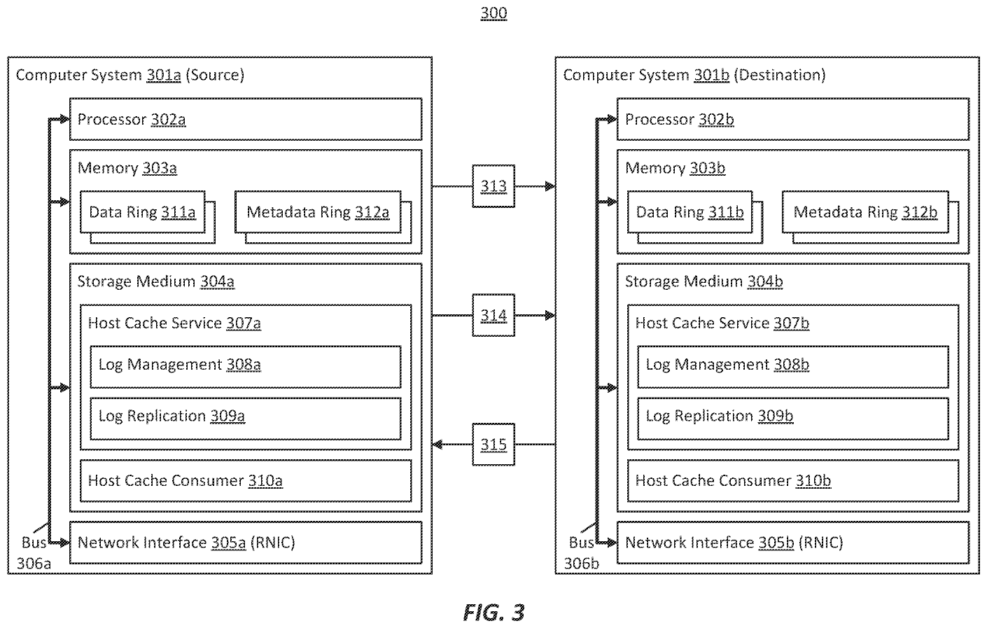

FIG. 3 illustrates an example 300 of a computer architecture that utilizes an RDMA replication model. Example 300 includes a computer system 301a acting as a source host and a computer system 301b acting as a destination host, both interconnected by a network (not shown). Within the context of cloud environment 100, for example, computer system 301a may correspond to host 101a, while computer system 301b corresponds to cache 110b. It is noted, however, that the principles described in connection with example 300 are applicable beyond VM/container hosting environments.

As shown, computer system 301a, 301b each includes a processor system (processor system 302a at computer system 301a, processor system 302b at host cache consumer 310b), a memory (memory 303a at computer system 301a, memory 303b at computer system 301b), a storage medium (storage medium 304a at computer system 301a, storage medium 304b at computer system 301b), and a network interface (network interface 305a at computer system 301a, network interface 305b at computer system 301b), each interconnected by a bus (bus 306a at computer system 301a, bus 306b at computer system 301b).

Referring to storage medium 304a, example 300 shows that computer system 301a includes a host cache service 307a (e.g., cache service 109a) that includes a log management component 308a and a log replication component 309a. In embodiments, host cache service 307a operates on behalf of a host cache consumer 310a (e.g., VM 102a, virtual storage controller 107a) to cache writes I/O operations initiated by the consumer.

Referring to storage medium 304b, example 300 shows that computer system 301b also includes a host cache service 307b (e.g., cache service 109b). In some embodiments, such as the one shown in example 300, host cache service 307b includes the same functionality as host cache service 307a (e.g., log management component 308b, a log replication component 309b) and is configured to operate on behalf of a host cache consumer 310b (e.g., VM 102b, virtual storage controller 107b). However, in other embodiments, host cache service 307b may operate as a log replication target without actually operating on behalf of any host cache consumer.

As shown in memory 303a, log management component 308a manages logs that are stored as separated data and metadata, as described in connection with example 200. Thus, in example 300, memory 303a is shown as storing a data ring 311a and a metadata ring 312a. For example, data ring 311a may correspond to data ring 201, while metadata ring 312a corresponds to metadata ring 203. Thus, for instance, entry 201a (data) and entry 203a (metadata) make up a single log stored in memory 303a. In embodiments, data ring 311a and metadata ring 312a are stored in a PMem portion of memory 303a. As indicated in FIG. 3, log management component 308a could manage multiple data and metadata rings.

In example 300, log replication component 309a uses RDMA to replicate logs (including their data and their metadata) from memory 303a to computer system 301b. Thus, memory 303b is shown as storing data ring 311b and metadata ring 312b, and network interface 305a, 305b are each shown as being RNICs. RDMA supports several operations, including a “write” operation and a “send” operation. The RDMA write operation is used to transfer data from a local memory region (e.g., memory 303a; write cache 112a within RAM 111a, from the perspective of host 101a) to a remote memory region (e.g., memory 303b; write cache 112b within RAM 111b, from the perspective of host 101a). The RDMA write operation does not involve the CPU at the remote end and is completed when data has been placed into a remote memory region.

The RDMA send operation is used to send data from a local memory region (e.g., a data area of write cache 1121) to a remote memory region (e.g., a data area of write cache 112b). Unlike the RDMA write operation, the RDMA send operation involves the remote CPU to move data from a temporary receive buffer at the remote system into the remote system's memory (e.g., a metadata area of write cache 112b).

Embodiments utilize the RDMA write and RDMA send operations, combined with separated data and metadata, to provide a novel RDMA replication model that ensures data visibility and crash consistency. In these embodiments, when replicating data (e.g., the data of one or more write cache logs) from a source host (e.g., computer system 301a) to a destination (e.g., computer system 301b), a host cache service (e.g., host cache service 307a) uses an RDMA write operation to replicate the data to the destination host. For example, log replication component 309a at computer system 301a uses an RDMA write operation 313 to replicate entry 201a from data ring 311a (e.g., write cache 112a) to data ring 311b (e.g., write cache 112b). This RDMA write operation 313 places the data into the destination host's memory (e.g., memory 303b)—which may comprise volatile memory such as DRAM and/or non-volatile memory such as PMem-without involving the destination host's CPU (e.g., processor system 302b). When the destination host's CPU is not involved, I/O latency is reduced as compared to techniques, such as traditional networks, that would involve the destination host's CPU. This also means that the data reaches the destination host's memory without the involvement of the destination host's CPU cache hierarchy (e.g., a zero-copy operation), which further reduces I/O latency.

In embodiments, after sending data to the destination host with an RDMA write operation, the source host uses an RDMA send operation to replicate the corresponding metadata to the destination host. For example, log replication component 309a at computer system 301a uses an RDMA send operation 314 to replicate entry 203a (e.g., the metadata corresponding to entry 201a) from metadata ring 312a (e.g., write cache 112a) to metadata ring 312b (e.g., write cache 112b). Unlike the RDMA write operation, the RDMA send operation requires the involvement of the destination host's CPU.

Using an RDMA write operation to replicate data, followed by using an RDMA send operation to replicate corresponding metadata, has a two-fold benefit. First, processing the RDMA send operation at the destination host ensures that prior written data (e.g., the data previously sent to it using the RDMA write operation) is flushed from the destination host's PCIe cache to memory. Flushing this prior writing data means that the data has been copied from the host's PCIe cache to the host's memory. Due to strict ordering guarantees provided by the RDMA protocol, and due to the RDMA send operation being issued after the RDMA write operation, processing the RDMA send operation guarantees full completion of the prior RDMA write operation at the destination host. Second, processing the RDMA send operation gives the destination host a chance to acknowledge the replication (e.g., acknowledge receipt of an RDMA write and subsequent RDMA send). In embodiments, the destination host acknowledges the replication by sending an RDMA send operation 315 to the source host. In embodiments, this RDMA send operation initiated by the destination host includes relevant information, such as status (e.g., success). When the source host receives this RDMA send initiated by the destination host, the source host can infer that both its RDMA write (data) and RDMA send (metadata) to the destination host have been completed at the destination host.

Thus, an RDMA data replication model that includes sending data with an RDMA write operation, followed by sending metadata with an RDMA send operation, ensures data consistency, e.g., in the event of a crash. More specifically, this RDMA data replication model guarantees that data and its corresponding metadata are both stored in the destination host's memory before the source host commits the I/O operation (e.g., to host cache consumer 310a). Additionally, if the data is persisted to non-volatile memory such as PMem at the destination host, then, after a destination host restarts, for any metadata present in the non-volatile memory, there is a guarantee that the corresponding data is also present in the non-volatile memory.

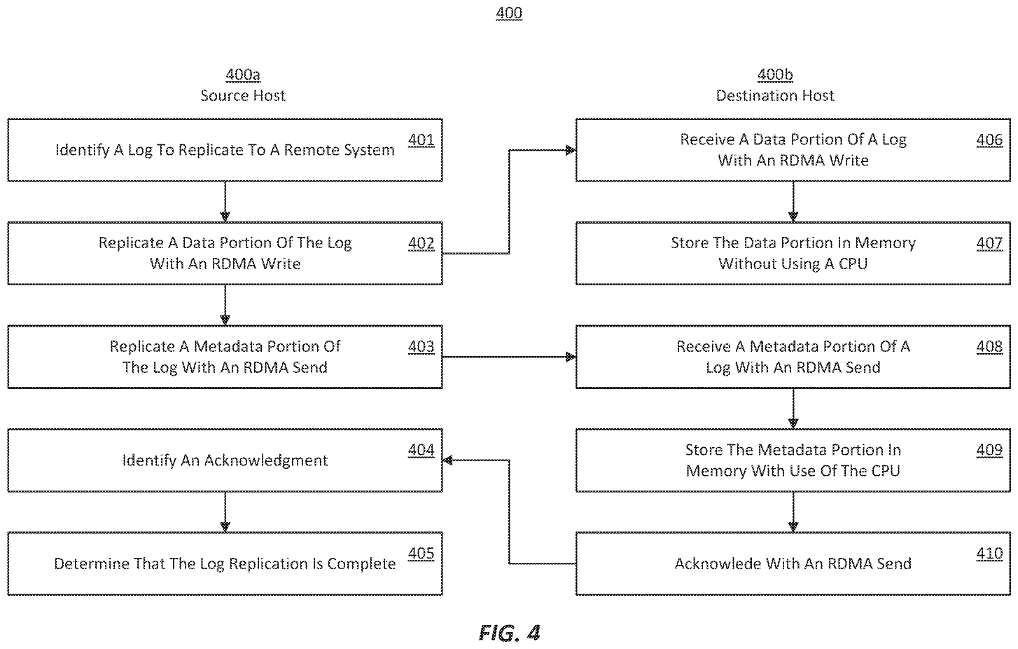

Embodiments are now described in connection with FIG. 4, which illustrates a flow chart of an example method 400 for using an RDMA replication model to replicate a log. As shown, method 400 includes method 400a at a source host (e.g., host 101a) and method 400b performed at a destination host (e.g., host 101b). In embodiments, instructions for implementing method 400a are encoded as computer-executable instructions (e.g., host cache service 307a) stored on a computer storage medium (e.g., storage medium 304a) that are executable by a processor (e.g., processor system 302a) to cause a source host computer system (e.g., computer system 301a) to perform method 400a. In embodiments, instructions for implementing method 400b are encoded as computer-executable instructions (e.g., host cache service 307b) stored on a computer storage medium (storage medium 304b) that are executable by a processor (e.g., processor system 302b) to cause a destination host computer system (e.g., computer system 301b) to perform method 400b.

The following discussion now refers to a number of methods and method acts. Although the method acts are discussed in specific orders or are illustrated in a flow chart as occurring in a particular order, no order is required unless expressly stated or required because an act is dependent on another act being completed prior to the act being performed.

Referring to FIG. 4, from the perspective of a source host (e.g., host 101a), method 400a comprises act 401 of identifying a log to replicate to a remote system. In some embodiments, act 401 comprises identifying a log for replication to a remote computer system, the log comprising a data portion and a metadata portion. For example, log replication component 309a at computer system 301a identifies a log comprising data (e.g., entry 201a stored in data ring 311a) and metadata (e.g., entry 203a stored in metadata ring 312a) for replication to computer system 301b.

As noted in connection with examples 200 and 300, in embodiments, the data portion is stored in a first ring buffer (e.g., data ring 311a) within a memory, and the metadata portion is stored in a second ring buffer (e.g., metadata ring 312a) within the memory. In embodiments, the size of the data portion is a multiple of a size of a memory page in the computer system.

While method 400a is applicable within various contexts, in some embodiments, the log is stored in a write cache (e.g., write cache 112a) managed by a host cache service (e.g., cache service 109a). In some embodiments, the write cache is stored in PMem.

Method 400a also comprises act 402 of replicating a data portion of the log with an RDMA write. In some embodiments, act 402 comprises sending the data portion to the remote computer system using RDMA write operation. For example, log replication component 309a sends entry 201a to computer system 301b using an RDMA write operation 313. As discussed later in connection with act 407, this causes computer system 301b to store entry 201a into memory 303b (e.g., data ring 311b) without involving processor system 302b.

Method 400b also comprises act 403 of replicating a metadata portion of the log with an RDMA send. In some embodiments, act 403 comprises sending the metadata portion to the remote computer system using a first RDMA send operation after sending the data portion to the remote computer system using the RDMA write operation. For example, after sending entry 201a with an RDMA write, log replication component 309a sends entry 203a to computer system 301b using an RDMA send operation 314. As discussed later in connection with act 409, this causes computer system 301b to store entry 203a into memory 303b (e.g., metadata ring 312b) with the use of processor system 302b.

Method 400a also comprises act 404 of identifying an acknowledgment. In some embodiments, act 404 comprises identifying a second RDMA send operation received from the remote computer system, the second RDMA send operation signaling completion of the first RDMA send operation. For example, log replication component 309a identifies an RDMA send operation 315 received from computer system 301b as a result of computer system 301b processing the RDMA send operation 314 of act 403. In embodiments, the second RDMA send operation includes an indication of a status, such as a success status.

Method 400a also comprises act 405 of determining that the log replication is complete. In some embodiments, act 405 comprises determining the completion of replication of the log to the remote computer system based on identifying the second RDMA send operation. For example, based on identifying the RDMA send operation 315 in act 404, log replication component 309a determines that the log identified in act 401 has been successfully replicated to computer system 301b.

In some embodiments, method 400a is performed by host cache service 307a as part of supporting an I/O operation by host cache consumer 310a. In these embodiments, method 400a may also include identifying an I/O operation (e.g., an I/O operation initiated by host cache consumer 310a), generating the log from the I/O operation (e.g., by log management component 308a), and committing the I/O operation based on determining the completion of the replication of the log to the remote computer system (e.g., notifying host cache consumer 310a that the I/O operation is complete). In some embodiments, host cache consumer 310a is a virtual storage controller. In these embodiments, the I/O operation is identified from a virtual storage controller (e.g., a virtual NVMe controller), and committing the I/O operation includes notifying the virtual storage controller. In some embodiments, based on identifying the RDMA send operation, host cache service 307a de-stages the log to a backing store (e.g., backing store 118).

Turning to the perspective of a destination host (e.g., host 101b), method 400b comprises act 406 of receiving a data portion of a log with an RDMA write. In some embodiments, act 406 comprises receiving an RDMA write operation from a remote computer system, the RDMA write operation comprising a data portion of a log. For example, computer system 301b receives RDMA write operation 313 initiated by computer system 301a in act 402.

Method 400b also comprises act 407 of storing the data portion in memory without using a CPU. In some embodiments, act 407 comprises storing the data portion of the log within memory without the use of a processor system. For example, because RDMA write operation 313 used an RDMA write operation 313, a PCIe bus at computer system 301b writes entry 201a to memory 303b (e.g., data ring 311b) without use of processor system 302b.

Method 400b also comprises act 408 of receiving a metadata portion of a log with an RDMA send. In some embodiments, act 408 comprises receiving the first RDMA send operation from the remote computer system, the first RDMA send operation comprising a metadata portion of the log. For example, computer system 301b receives the RDMA send operation 314 initiated by computer system 301a in act 403.

Method 400b also comprises act 409 of storing the metadata portion in memory with the use of the CPU. In some embodiments, act 409 comprises storing the metadata portion of the log within memory with the use of the processor system. For example, because computer system 301a used an RDMA send operation 314, processor system 302b at host cache consumer 310b writes entry 203a to memory 303b (e.g., metadata ring 312b).

Method 400b also comprises act 410 of acknowledging with an RDMA send. In some embodiments, act 410 comprises sending a second RDMA send operation to the remote computer system after storing the metadata portion of the log in the memory. For example, log replication component 309b at computer system 301b initiates an RDMA send operation 315 to computer system 301a. In embodiments, the second RDMA send operation includes an indication of a status, such as a success status.

As noted in connection with examples 200 and 300, in embodiments, the data portion is stored in a first ring buffer (e.g., data ring 311b) within memory 303b, and the metadata portion is stored in a second ring buffer (e.g., metadata ring 312b) within the memory. In embodiments, the size of the data portion is a multiple of a size of a memory page in the computer system.

While method 400b is applicable within various contexts, in some embodiments, the log is stored in a write cache (e.g., write cache 112a) managed by a host cache service (e.g., cache service 109a). In some embodiments, the write cache is stored in PMem.

Embodiments of the disclosure comprise or utilize a special-purpose or general-purpose computer system (e.g., computer system 301a, computer system 301b) that includes computer hardware, such as, for example, a processor system and system memory (e.g., memory 303a, memory 303b), as discussed in greater detail below. Embodiments within the scope of the present disclosure also include physical and other computer-readable media (e.g., storage medium 304a, storage medium 304b) for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more CPUs, one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system, comprising:
identifying a log for replication to a remote computer system, the log comprising a data portion and a metadata portion;
sending the data portion to the remote computer system using a Remote Direct Memory Access (RDMA) write operation;
sending the metadata portion to the remote computer system using a first RDMA send operation after sending the data portion to the remote computer system using the RDMA write operation;
identifying a second RDMA send operation received from the remote computer system, the second RDMA send operation signaling completion of the first RDMA send operation; and
determining a completion of replication of the log to the remote computer system based on identifying the second RDMA send operation.

2. The method of claim 1, wherein the log is stored in a write cache managed by a host cache service.

3. The method of claim 2, wherein the write cache is stored in a persistent memory.

4. The method of claim 1, wherein the data portion is stored in a first ring buffer within a memory, and the metadata portion is stored in a second ring buffer within the memory.

5. The method of claim 1, wherein a size of the data portion is a multiple of a size of a memory page in the computer system.

6. The method of claim 1, wherein the method further comprises:
identifying an input/output (I/O) operation;
generating the log from the I/O operation; and
committing the I/O operation based on determining the completion of the replication of the log to the remote computer system.

7. The method of claim 6, wherein,
the I/O operation is identified from a virtual storage controller; and
committing the I/O operation comprises notifying the virtual storage controller.

8. The method of claim 7, wherein the virtual storage controller is a virtual Non-Volatile Memory Express (NVMe) controller.

9. The method of claim 1, wherein the second RDMA send operation comprises an indication of a success status.

10. The method of claim 1, wherein the method further comprises de-staging the log to a backing store.

11. A method implemented in a computer system that includes a processor system, comprising:
receiving a Remote Direct Memory Access (RDMA) write operation from a remote computer system, the RDMA write operation comprising a data portion of a log;
storing the data portion of the log in a memory without use of the processor system;
receiving a first RDMA send operation from the remote computer system, the first RDMA send operation comprising a metadata portion of the log;
storing the metadata portion of the log in the memory with use of the processor system; and
sending a second RDMA send operation to the remote computer system after storing the metadata portion of the log in the memory.

12. The method of claim 11, wherein the data portion of the log and the metadata portion of the log are stored in a write cache managed by a host cache service.

13. The method of claim 12, wherein the write cache is stored in a persistent memory.

14. The method of claim 11, wherein the data portion is stored in a first ring buffer within the memory, and the metadata portion is stored in a second ring buffer within the memory.

15. The method of claim 11, wherein a size of the data portion is a multiple of a size of a memory page in the computer system.

16. The method of claim 11, wherein the second RDMA send operation comprises an indication of a success status.

17. A computer system, comprising:
a processor system; and
a computer storage medium that stores computer-executable instructions that are executable by the processor system to at least:
identify a log for replication to a remote computer system, the log comprising a data portion and a metadata portion;
send the data portion to the remote computer system using a Remote Direct Memory Access (RDMA) write operation;
send the metadata portion to the remote computer system using a first RDMA send operation after sending the data portion to the remote computer system using the RDMA write operation;
identify a second RDMA send operation received from the remote computer system, the second RDMA send operation signaling completion of the first RDMA send operation; and
de-stage the log to a backing store based on identifying the second RDMA send operation.

18. The computer system of claim 17, wherein the data portion is stored in a first ring buffer within a memory, and the metadata portion is stored in a second ring buffer within the memory.

19. The computer system of claim 17, wherein a size of the data portion is a multiple of a size of a memory page in the computer system.

20. The computer system of claim 17, wherein the computer-executable instructions are also executable by the processor system to at least:
identify an input/output (I/O) operation;
generate the log from the I/O operation; and
commit the I/O operation based on identifying the second RDMA send operation.
